(19) United States
(12) Patent Application Publication
(10) Pub. No.: US 2024/0323552 A1
(43) Pub. Date: Sep. 26, 2024

(54) SOLID-STATE IMAGING DEVICE AND METHOD FOR OPERATING A SOLID-STATE IMAGING DEVICE

(71) Applicant: Sony Semiconductor Solutions Corporation, Atsugi-shi, Kanagawa (JP)

(72) Inventor: Diederik Paul MOEYS, Stuttgart (DE)

(73) Assignee: Sony Semiconductor Solutions Corporation, Atsugi-shi, Kanagawa (JP)

(21) Appl. No.: 18/577,704

(22) PCT Filed: Jul. 21, 2022
(86) PCT No.: PCT/EP2022/070444

§ 371 Date: Jan. 9, 2024

(30) Foreign Application Priority Data
Jul. 22, 2021 (EP) 21187158.7

(51) Int. Cl. H04N 25/47; H04N 25/773; H04N 25/79

(52) U.S. Cl. CPC H04N 25/47; H04N 25/773; H04N 25/79

(57) ABSTRACT

A solid state imaging device comprises a pixel array comprising a plurality of imaging pixels, each of which being capable to detect as a positive polarity event a rise of intensity of light falling on the imaging pixel which rise is larger than a respective first predetermined threshold or as a negative polarity event a fall of the intensity which fall is larger than a respective second predetermined threshold, and a control unit that is configured to receive a time series of the events of both polarities detected in the pixel array, to deduce from the time series of events information on the absolute light intensity received from objects whose movements caused the events, and to reconstruct a time series of images of the objects.

### FIELD OF THE INVENTION

The present disclosure relates to a solid-state imaging device and a method for operating the same. In particular, the present disclosure is related to the field of event detection sensors reacting to changes in light intensity, such as dynamic vision sensors (DVS).

### BACKGROUND

Computer vision deals with how machines and computers can gain high-level understanding from digital images or videos. Typically, computer vision methods aim at excerpting, from raw image data obtained through an image sensor, that type of information the machine or computer uses for other tasks.

Many applications such as machine control, process monitoring or surveillance tasks are based on the evaluation of the movement of objects in the imaged scene. Conventional image sensors with a plurality of pixels arranged in an array of pixels deliver a sequence of still images (frames). Detecting moving objects in the sequence of frames typically involves elaborate and expensive image processing methods.

Event detection sensors like DVS tackle the problem of motion detection by delivering only information about the position of changes in the imaged scene. Unlike image sensors that transfer large amounts of image information in frames, transfer of information about pixels that do not change may be omitted, resulting in a sort of in-pixel data compression. The in-pixel data compression removes data redundancy and facilitates high temporal resolution, low latency, low power consumption, and high dynamic range with little motion blur. DVS are thus well suited especially for solar or battery powered compressive sensing or for mobile machine vision applications where the motion of the system including the image sensor has to be estimated and where processing power is limited due to limited battery capacity. In principle the architecture of DVS allows for high dynamic range and good low-light performance.

It is desirable to utilize and push further the inherent high dynamic range, high temporal resolution and good low-light performance of photoreceptor modules, image sensors adapted for event detection like DVS.

### SUMMARY OF INVENTION

Event-based Vision Sensors (EVS), like DVS, often have a logarithmic front-end. The speed of this type of photoreceptor circuit has inherently a dependence on the photocurrent and hence on the illumination at the pixel. This illumination-dependent time constant causes trails of events when bright objects pass in front of darker backgrounds. These trails could deteriorate the precision of the images reconstructed from the detected events.

The present disclosure mitigates these shortcomings of conventional event detection by exploiting this trail (or trace) effect for the purpose of image reconstruction, as it inherently contains information about the scene brightness.

To this end, a solid state imaging device is provided that comprises a pixel array comprising a plurality of imaging pixels, each of which being capable to detect as a positive polarity event a rise of intensity of light falling on the imaging pixel which rise is larger than a respective first predetermined threshold or as a negative polarity event a fall of the intensity which fall is larger than a respective second predetermined threshold, and a control unit that is configured to receive a time series of the events of both polarities detected in the pixel array, to deduce from the time series of events information on the absolute light intensity received from objects whose movements caused the events, and to reconstruct a time series of images of the objects.

Further, a method is provided for operating a solid state imaging device that comprises a pixel array comprising a plurality of imaging pixels, each of which being capable to detect as a positive polarity event a rise of intensity of light falling on the imaging pixel which rise is larger than a respective first predetermined threshold or as a negative polarity event a fall of the intensity which fall is larger than a respective second predetermined threshold, the method comprising: detecting a time series of events of both pluralities, deducing from the time series of events information on the absolute light intensity received from objects whose movements caused the events, and reconstructing a time series of images of the objects.

By using information on both positive and negative polarity events detected during a given time period, it is possible to obtain additional information about the absolute light intensity received at the imaging pixels. This can help to improve the accuracy and reliability of images reconstructed from the input time series of events.

### BRIEF DESCRIPTION OF THE DRAWINGS

FIG. 1A is a simplified block diagram of the event detection circuitry of a solid state imaging device including a pixel array.

FIG. 1B is a simplified block diagram of the pixel array illustrated in FIG. 1A.

FIG. 1C is a simplified block diagram of the imaging signal read-out circuitry of the solid state imaging device of FIG. 1A.

FIG. 2 is a simplified block diagram of the solid state imaging device.

FIGS. 3a) and 3b) are simplified images explaining the occurrences of trails of negative polarity events.

FIGS. 4A and 4B are simplified diagrams explaining the occurrences of trails of negative polarity events.

FIG. 5 is a simplified process flow of the solid-state imaging device.

FIG. 6 is a simplified process flow of a method for operating the solid-state imaging device.

FIG. 7 is a simplified perspective view of a solid-state imaging device with laminated structure.

FIG. 8 illustrates simplified diagrams of configuration examples of a multi-layer solid-state imaging device to which a technology according to the present disclosure may be applied.

FIG. 9 is a block diagram depicting an example of a schematic configuration of a vehicle control system.

FIG. 10 is a diagram of assistance in explaining an example of installation positions of an outside-vehicle information detecting section and an imaging section of the vehicle control system of FIG. 9.

### DETAILED DESCRIPTION

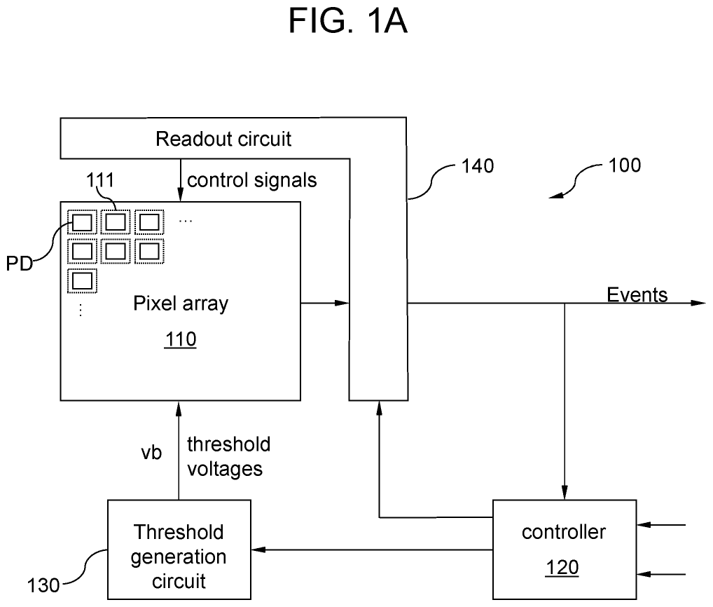

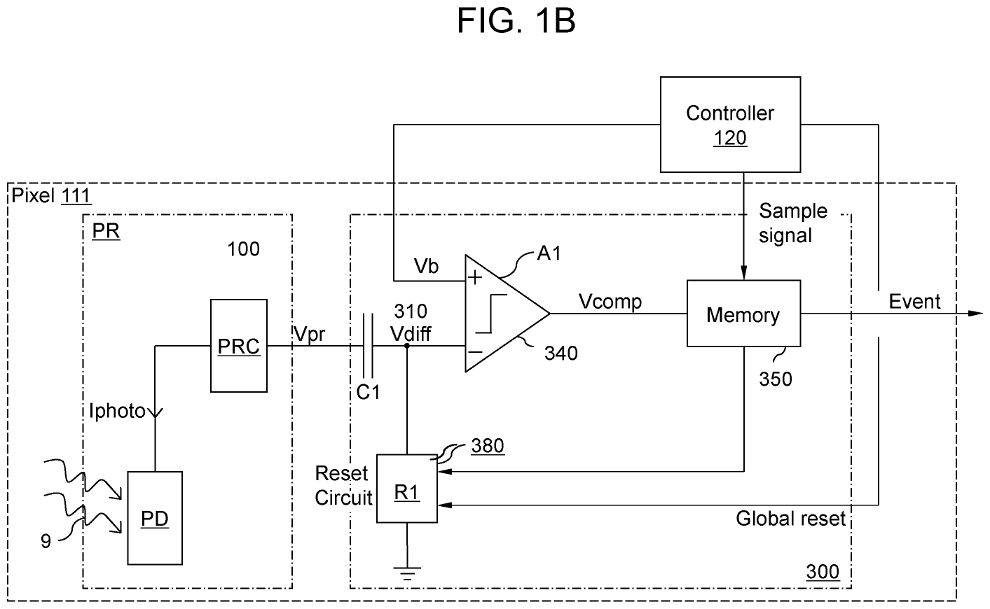

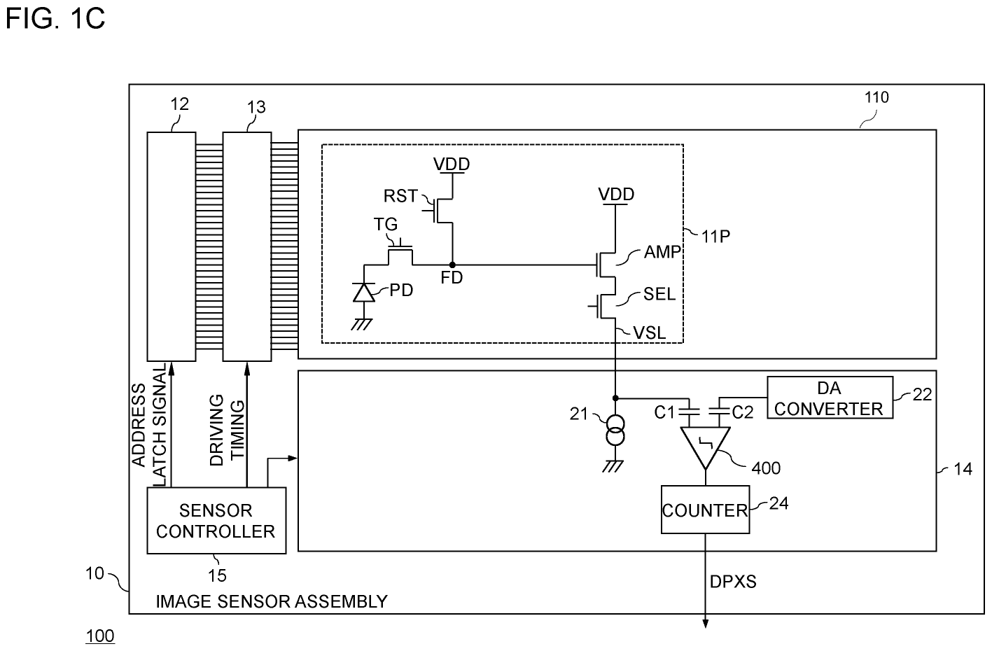

FIG. 1A is a block diagram of a solid-state imaging device 100 employing event based change detection. The solid-state imaging device 100 includes a pixel array 110 with one or more imaging pixels 111, wherein each pixel 111 includes a photoelectric conversion element PD. The pixel array 110 may be a one-dimensional pixel array with the photoelectric conversion elements PD of all pixels arranged along a straight or meandering line (line sensor). In particular, the pixel array 110 may be a two-dimensional array, wherein the photoelectric conversion elements PDs of the pixels 111 may be arranged along straight or meandering rows and along straight or meandering lines.

The illustrated embodiment shows a two dimensional array of pixels 111, wherein the pixels 111 are arranged along straight rows and along straight columns running orthogonal the rows. Each pixel 111 converts incoming light into an imaging signal representing the incoming light intensity and an event signal indicating a change of the light intensity, e.g. an increase by at least an upper threshold amount (positive polarity events) and/or a decrease by at least a lower threshold amount (negative polarity events). If necessary, the function of each pixel 111 regarding intensity and event detection may be divided and different pixels observing the same solid angle can implement the respective functions. These different pixels may be subpixels and can be implemented such that they share part of the circuitry. The different pixels may also be part of different image sensors. For the present disclosure, whenever it is referred to a pixel capable of generating an imaging signal and an event signal, this should be understood to include also a combination of pixels separately carrying out these functions as described above. The imaging pixels 111 may also be capable of only producing event signals.

A controller 120 performs a flow control of the processes in the pixel array 110. For example, the controller 120 may control a threshold generation circuit 130 that determines and supplies thresholds to individual pixels 111 in the pixel array 110. A readout circuit 140 provides control signals for addressing individual pixels 111 and outputs information about the position of such pixels 111 that indicate an event. Since the solid-state imaging device 100 employs event-based change detection, the readout circuit 140 may output a variable amount of data per time unit.

FIG. 1B shows exemplarily details of the imaging pixels 111 in FIG. 1A as far as their event detection capabilities are concerned. Of course, any other implementation that allows detection of events can be employed. Each pixel 111 includes a photoreceptor module PR and is assigned to a pixel back-end 300, wherein each complete pixel back-end 300 may be assigned to one single photoreceptor module PR. Alternatively, a pixel back-end 300 or parts thereof may be assigned to two or more photoreceptor modules PR, wherein the shared portion of the pixel back-end 300 may be sequentially connected to the assigned photoreceptor modules PR in a multiplexed manner.

The photoreceptor module PR includes a photoelectric conversion element PD, e.g. a photodiode or another type of photosensor. The photoelectric conversion element PD converts impinging light 9 into a photocurrent Iphoto through the photoelectric conversion element PD, wherein the amount of the photocurrent Iphoto is a function of the light intensity of the impinging light 9.

A photoreceptor circuit PRC converts the photocurrent Iphoto into a photoreceptor signal Vpr. The voltage of the photoreceptor signal Vpr is a function of the photocurrent Iphoto.

A memory capacitor 310 stores electric charge and holds a memory voltage which amount depends on a past photoreceptor signal Vpr. In particular, the memory capacitor 310 receives the photoreceptor signal Vpr such that a first electrode of the memory capacitor 310 carries a charge that is responsive to the photoreceptor signal Vpr and thus the light received by the photoelectric conversion element PD. A second electrode of the memory capacitor C1 is connected to the comparator node (inverting input) of a comparator circuit 340. Thus the voltage of the comparator node, Vdiff varies with changes in the photoreceptor signal Vpr.

The comparator circuit 340 compares the difference between the current photoreceptor signal Vpr and the past photoreceptor signal to a threshold. The comparator circuit 340 can be in each pixel back-end 300, or shared between a subset (for example a column) of pixels. According to an example each pixel 111 includes a pixel back-end 300 including a comparator circuit 340, such that the comparator circuit 340 is integral to the imaging pixel 111 and each imaging pixel 111 has a dedicated comparator circuit 340.

A memory element 350 stores the comparator output in response to a sample signal from the controller 120. The memory element 350 may include a sampling circuit (for example a switch and a parasitic or explicit capacitor) and/or a digital memory circuit such as a latch or a flip-flop). In one embodiment, the memory element 350 may be a sampling circuit. The memory element 350 may be configured to store one, two or more binary bits.

An output signal of a reset circuit 380 may set the inverting input of the comparator circuit 340 to a predefined potential. The output signal of the reset circuit 380 may be controlled in response to the content of the memory element 350 and/or in response to a global reset signal received from the controller 120.

The solid-state imaging device 100 is operated as follows: A change in light intensity of incident radiation 9 translates into a change of the photoreceptor signal Vpr. At times designated by the controller 120, the comparator circuit 340 compares Vdiff at the inverting input (comparator node) to a threshold Vb applied on its non-inverting input. At the same time, the controller 120 operates the memory element 350 to store the comparator output signal Vcomp. The memory element 350 may be located in either the pixel circuit 111 or in the readout circuit 140 shown in FIG. 1A.

If the state of the stored comparator output signal indicates a change in light intensity AND the global reset signal GlobalReset (controlled by the controller 120) is active, the conditional reset circuit 380 outputs a reset output signal that resets Vdiff to a known level.

The memory element 350 may include information indicating a change of the light intensity detected by the pixel 111 by more than a threshold value.

The controller 120 may output the addresses (where the address of a pixel 111 corresponds to its row and column number) of those pixels 111 where a light intensity change has been detected. A detected light intensity change at a given pixel is called an event. More specifically, the term ‘event’ means that the photoreceptor signal representing and being a function of light intensity of a pixel has changed by an amount greater than or equal to a threshold applied by the controller through the threshold generation circuit 130. To transmit an event, the address of the corresponding pixel 111 is transmitted along with data indicating whether the light intensity change was positive or negative. The data indicating whether the light intensity change was positive or negative may include one single bit. Further, also the amount of intensity change, i.e. information on the relative brightness before and after the event may be transmitted.

To detect light intensity changes between current and previous instances in time, each pixel 111 stores a representation of the light intensity at the previous instance in time.

More concretely, each pixel 111 stores a voltage Vdiff representing the difference between the photoreceptor signal at the time of the last event registered at the concerned pixel 111 and the current photoreceptor signal at this pixel 111.

To detect events, Vdiff at the comparator node may be first compared to a first threshold to detect an increase in light intensity (ON-event), and the comparator output is sampled on a (explicit or parasitic) capacitor or stored in a flip-flop. Then Vdiff at the comparator node is compared to a second threshold to detect a decrease in light intensity (OFF-event) and the comparator output is sampled on a (explicit or parasitic) capacitor or stored in a flip-flop.

The global reset signal is sent to all pixels 111, and in each pixel 111 this global reset signal is logically ANDed with the sampled comparator outputs to reset only those pixels where an event has been detected. Then the sampled comparator output voltages are read out, and the corresponding pixel addresses sent to a data receiving device. FIG. 1C illustrates a configuration example of the solid-state imaging device 100 including an image sensor assembly 10 that is used for readout of intensity imaging signals in form of an active pixel sensor, APS. Here, FIG. 1C is purely exemplary. Readout of imaging signals can also be implemented in any other known manner. As stated above, the image sensor assembly 10 may use the same pixels 111 or may supplement these pixels 111 with additional pixels observing the respective same solid angles. In the following description the exemplary case of usage of the same pixel array 110 is chosen.

The image sensor assembly 10 includes the pixel array 110, an address decoder 12, a pixel timing driving unit 13, an ADC (analog-to-digital converter) 14, and a sensor controller 15.

The pixel array 110 includes a plurality of pixel circuits 11P arranged matrix-like in rows and columns. Each pixel circuit 11P includes a photosensitive element and FETs (field effect transistors) for controlling the signal output by the photosensitive element.

The address decoder 12 and the pixel timing driving unit 13 control driving of each pixel circuit 11P disposed in the pixel array 110. That is, the address decoder 12 supplies a control signal for designating the pixel circuit 11P to be driven or the like to the pixel timing driving unit 13 according to an address, a latch signal, and the like supplied from the sensor controller 15. The pixel timing driving unit 13 drives the FETs of the pixel circuit 11P according to driving timing signals supplied from the sensor controller 15 and the control signal supplied from the address decoder 12. The electric signals of the pixel circuits 11P (pixel output signals, imaging signals) are supplied through vertical signal lines VSL to ADCs 14, wherein each ADC 14 is connected to one of the vertical signal lines VSL, and wherein each vertical signal line VSL is connected to all pixel circuits 11P of one column of the pixel array unit 11. Each ADC 14 performs an analog-to-digital conversion on the pixel output signals successively output from the column of the pixel array unit 11 and outputs the digital pixel data DPXS to the signal processing unit 19. To this purpose, each ADC 14 includes a comparator 23, a digital-to-analog converter (DAC) 22 and a counter 24.

The sensor controller 15 controls the image sensor assembly 10. That is, for example, the sensor controller 15 supplies the address and the latch signal to the address decoder 12, and supplies the driving timing signal to the pixel timing driving unit 13. In addition, the sensor controller 15 may supply a control signal for controlling the ADC 14.

The pixel circuit 11P includes the photoelectric conversion element PD as the photosensitive element. The photoelectric conversion element PD may include or may be composed of, for example, a photodiode. With respect to one photoelectric conversion element PD, the pixel circuit 11P may have four FETs serving as active elements, i.e., a transfer transistor TG, a reset transistor RST, an amplification transistor AMP, and a selection transistor SEL.

The photoelectric conversion element PD photoelectrically converts incident light into electric charges (here, electrons). The amount of electric charge generated in the photoelectric conversion element PD corresponds to the amount of the incident light.

The transfer transistor TG is connected between the photoelectric conversion element PD and a floating diffusion region FD. The transfer transistor TG serves as a transfer element for transferring charge from the photoelectric conversion element PD to the floating diffusion region FD. The floating diffusion region FD serves as temporary local charge storage. A transfer signal serving as a control signal is supplied to the gate (transfer gate) of the transfer transistor TG through a transfer control line.

Thus, the transfer transistor TG may transfer electrons photoelectrically converted by the photoelectric conversion element PD to the floating diffusion FD.

The reset transistor RST is connected between the floating diffusion FD and a power supply line to which a positive supply voltage VDD is supplied. A reset signal serving as a control signal is supplied to the gate of the reset transistor RST through a reset control line.

Thus, the reset transistor RST serving as a reset element resets a potential of the floating diffusion FD to that of the power supply line.

The floating diffusion FD is connected to the gate of the amplification transistor AMP serving as an amplification element. That is, the floating diffusion FD functions as the input node of the amplification transistor AMP serving as an amplification element.

The amplification transistor AMP and the selection transistor SEL are connected in series between the power supply line VDD and a vertical signal line VSL.

Thus, the amplification transistor AMP is connected to the signal line VSL through the selection transistor SEL and constitutes a source-follower circuit with a constant current source 21 illustrated as part of the ADC 14.

Then, a selection signal serving as a control signal corresponding to an address signal is supplied to the gate of the selection transistor SEL through a selection control line, and the selection transistor SEL is turned on.

When the selection transistor SEL is turned on, the amplification transistor AMP amplifies the potential of the floating diffusion FD and outputs a voltage corresponding to the potential of the floating diffusion FD to the signal line VSL. The signal line VSL transfers the pixel output signal from the pixel circuit 11P to the ADC 14.

Since the respective gates of the transfer transistor TG, the reset transistor RST, and the selection transistor SEL are, for example, connected in units of rows, these operations are simultaneously performed for each of the pixel circuits 11P of one row. Further, it is also possible to selectively read out single pixels or pixel groups.

The ADC 14 may include a DAC 22, the constant current source 21 connected to the vertical signal line VSL, a comparator 23, and a counter 24.

The vertical signal line VSL, the constant current source 21 and the amplifier transistor AMP of the pixel circuit 11P combine to a source follower circuit.

The DAC 22 generates and outputs a reference signal. By performing digital-to-analog conversion of a digital signal increased in regular intervals, e.g. by one, the DAC 22 may generate a reference signal including a reference voltage ramp. Within the voltage ramp, the reference signal steadily increases per time unit. The increase may be linear or not linear.

The comparator 23 has two input terminals. The reference signal output from the DAC 22 is supplied to a first input terminal of the comparator 23 through a first capacitor C1. The pixel output signal transmitted through the vertical signal line VSL is supplied to the second input terminal of the comparator 23 through a second capacitor C2.

The comparator 23 compares the pixel output signal and the reference signal that are supplied to the two input terminals with each other, and outputs a comparator output signal representing the comparison result. That is, the comparator 23 outputs the comparator output signal representing the magnitude relationship between the pixel output signal and the reference signal. For example, the comparator output signal may have high level when the pixel output signal is higher than the reference signal and may have low level otherwise, or vice versa. The comparator output signal VCO is supplied to the counter 24.

The counter 24 counts a count value in synchronization with a predetermined clock. That is, the counter 24 starts the count of the count value from the start of a P phase or a D phase when the DAC 22 starts to decrease the reference signal, and counts the count value until the magnitude relationship between the pixel output signal and the reference signal changes and the comparator output signal is inverted. When the comparator output signal is inverted, the counter 24 stops the count of the count value and outputs the count value at that time as the AD conversion result (digital pixel data DPXS) of the pixel output signal.

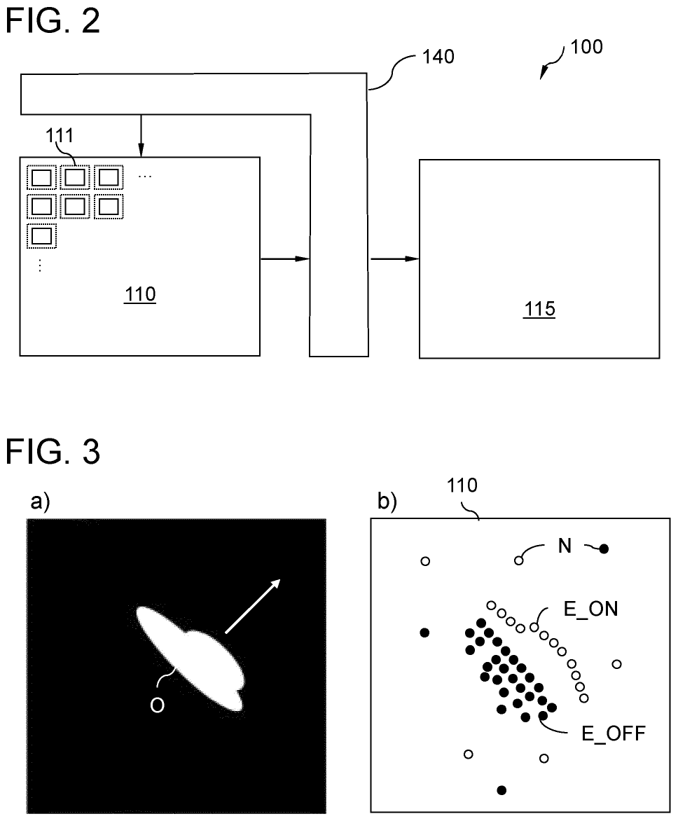

The above described structures can be used in a combined manner to gain information on absolute light intensities from the detected events. As shown in FIG. 2 a control unit 115 is included in the solid state imaging device 100 that may otherwise comprise the elements described above with respect to FIGS. 1A to 1C.

That is, the solid state imaging device 100 comprises at least the pixel array 110 that comprises the plurality of imaging pixels 111, each of which being capable to detect as a positive polarity event a rise of intensity of light falling on the imaging pixel 111 which rise is larger than a respective first predetermined threshold or as a negative polarity event a fall of the intensity which fall is larger than a respective second predetermined threshold, and the control unit 115. The control unit 115 may be any chip, circuitry, processor or the like that is capable to perform the functions described below. The control unit 115 may be provided separately to the circuitry described above with respect to FIGS. 1A to 1C or may be part of that circuitry. For example, the controller 120 and the control unit 115 may be constituted by the same processor.

The control unit 115 is configured to receive a time series of the events of both polarities that have been detected in the pixel array. From this time series of events the control unit 115 can deduce information on the absolute light intensity received from objects whose movements caused the events, which information can be used in reconstructing a time series of images of the objects.

That is, by monitoring the distribution of positive and negative polarity events the control unit 115 is able to deduce information on the received absolute light intensity via knowledge about the event detection characteristics of the imaging pixels 111 and the dependence of these characteristics on the absolute light intensity. The knowledge about the event detection characteristics may e.g. be obtained via calibration of the imaging pixels 111. Since the event detection characteristics depend on the received intensity, i.e. on the brightness of the observed objects, also the pattern and number of detected events will depend on this intensity. Different intensities of received light will therefore produce different distributions of positive and negative polarity events across the pixel array 110. Observing the temporal sequence of the detected events allows the control unit 115 to recognize spatial and/or temporal patterns in the event data which are characteristic for specific absolute brightness or intensity values. Thus, by an according observation the control unit 115 is capable to deduce information on the absolute light intensities that are received from the imaged objects.

It is therefore possible to obtain absolute intensity information from event data without transmitting actual intensity values observed by the imaging pixels 111. The amount of data generated by the solid state imaging device is therefore the same as in a conventional event (or dynamic) vision sensor, i.e. a lot smaller than the amount of data produced by full frame intensity measurements. Nevertheless, it is possible to deduce absolute intensity information that can help to improve image reconstruction. Thus, a time series of images of the objects, i.e. a reconstructed video of the observed objects, obtained only from event data can be adapted closer to the actual objects. This makes the reconstructed images (or the video) more accurate, and hence decisions based on these images (e.g. in autonomous driving) more reliable.

An example of patterns of events that allow deduction of absolute brightness information will be described with respect to FIG. 3. FIG. 3a) shows schematically the movement of a bright object O before a darker background as illustrated by the arrow. Note that the effects described below will in principle not only occur for a white object before a black background, i.e. for full contrast, but for any object that moves before a darker background.

As the object O moves in the direction of the arrow imaging pixels 111 will start to see it. The intensity observed by imaging pixels 111 into whose line of sight the object O moves will suddenly rise, producing in this manner a positive polarity or ON-event. When the object O leaves the line of sight of the respective imaging pixel, a negative polarity or OFF-event will be produced. This results in an event pattern across the pixel array 110 as shown in FIG. 3b). There is a line of ON-events E_ON having approximately the shape of the front of the object O. Moreover, there are OFF-events E_OFF at the back of the object O. In addition, events N of both polarities generated by noise may be present.

In contrast to the sharp edge formed by the ON-events at the front of the object O, the OFF-events seem to smear out the back edge of the object O. The reason for this event pattern is that the imaging pixels 111 as described above are capable of increasing their output voltage Vpr rather quickly when turning from dark to bright, while the output voltage Vpr will not decrease as quickly when turning from bright to dark. Thus, the output of the imaging pixels will become only gradually darker. However, while not as steep as the rise, the decrease is still so fast that in consecutive clock cycles of the intensity comparison for event detection, the event detection threshold will be crossed. Thus, imaging pixels 111 tend to detect events also after a bright object has passed them. If the brightness change is sufficiently large, it is also possible that a plurality of such OFF-events will be detected.

In an event pattern observed at a given time as the one shown in FIG. 3b) this will lead to trails or traces of OFF-events following an OFF-event on the back edge of the moving object O. Thus, trails of negative polarity events are generated by observing a movement of a bright object O before a darker background, which trails consist at a given time each of a plurality of events, and the of movements of which trails follow the movement of the bright object O, i.e. the trails are aligned with the movement direction of the object O projected on the plane of the pixel array 110.

The control unit 115 may then be configured to detect these trails of negative polarity events within the time series of events and to determine the information on the absolute light intensity received from the bright object O based on the detected trails that were generated by the bright object O, in particular based on the lengths of the detected trails.

In fact, since the shape of the trails and the number of events in the trails depend on the absolute brightness of the object O, it is possible to deduce absolute intensity information from the event data. So, intensity information can be provided to the control unit 115 without actually transmitting intensity values. This means that the information based on which image reconstruction is performed can be improved without increased data amount and without deteriorating the time resolution of the event based vision sensor.

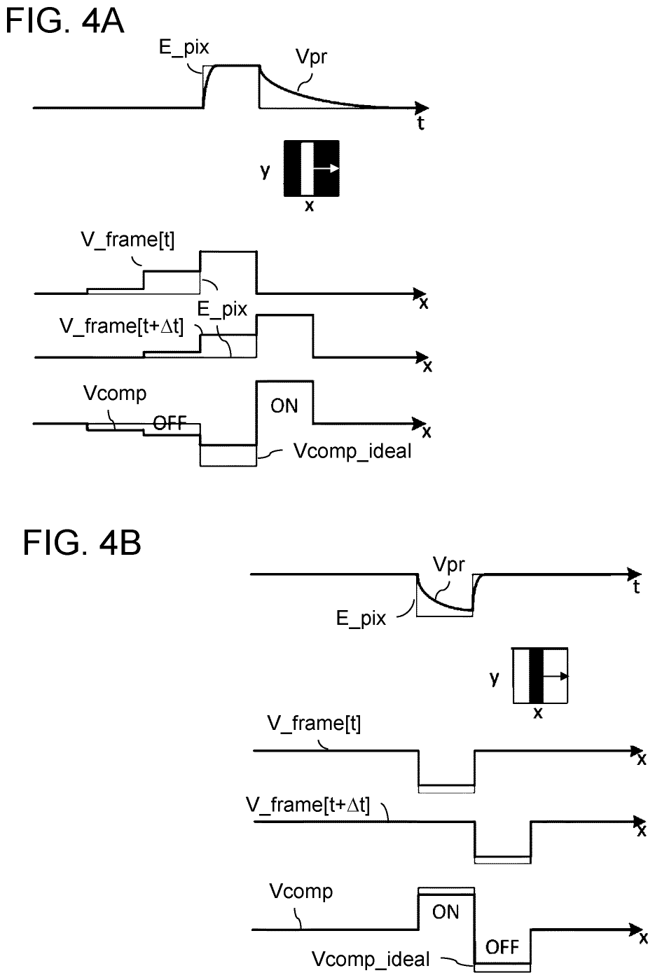

This will be explained in more detail with respect to FIGS. 4A and 4B. Here, FIG. 4A relates to the case of an ON-OFF-transition, while FIG. 4B relates the opposite case of an OFF-ON-transition.

At the top of FIG. 4A an ideal ON-OFF pulse E_pix is shown, i.e. an abrupt rise of intensity followed by an abrupt fall of the intensity. This variation of the intensity in time leads to the output voltage Vpr shown also at the top of FIG. 4A. When an imaging pixel 111 transitions from dark to bright, it suddenly becomes fast, i.e. the rise of the output voltage Vpr follows the rise of E_pix rather closely. However, when the opposite happens, the imaging pixel 111 becomes slower and slower such that it reaches its lowest value only asymptotically. The decrease of Vpr can therefore be described by an exponential decay having a time constant τ, i.e. Vpr˜exp[−ι/τ]. Thus, the transition will take some time causing effectively a trail of events as the transition will distribute the overall temporal contrast over time.

This can be understood with respect to the lower part of FIG. 4A. Here, the (quantized) output voltage of an imaging pixel row at time t, V_frame[t], is shown that is caused by a movement of the ideal ON-OFF pulse E_pix into the positive x-direction, which can be symbolized or simulated by the movement of a white bare before a black background. Due to the exponential decrease of the output voltage not only the imaging pixel 111 on which E_pix is momentarily located, but also the imaging pixels traversed previously will have positive output voltages.

After the time Δt E_pix will be moved to the next imaging pixel 111 in the positive x-direction. The corresponding output voltage V_frame[t+Δt] is equal to V_frame[t] up to the shift by one imaging pixel position.

The difference voltage Vcomp that is compared to the threshold for event detection is equal to Vframe[t+Δt]−V_frame[t]. As can be seen in the last line of FIG. 4A, instead of an ideal signal Vcomp_ideal that has one ON-peak and one OFF-peak, the OFF-peak is smeared out in Vcomp to a series of smaller voltage values at several pixel positions. Each of these differences may be larger than the event detection threshold, thus generating a trail of negative polarity events as schematically illustrated in FIG. 3b).

The number of events in one trail depends on the relative difference in brightness before and after the OFF-event. This relative difference is usually known from the event data. Moreover, the number of events in the trail depends on the value of the time constant τ. As a matter of fact, this value of the time constant depends on the initial brightness observed before the decrease of intensity, since this initial brightness determines the movability of charges in the imaging pixels 111 via the space charge region capacitance and the light-dependent conductance of the photodiode. The more light intensity is received by the imaging pixel 111, the higher will be its conductance, leading to a smaller time constant τ. Thus, the length of the trails of negative polarity events depends on the time constant τ, which in turn depends on the absolute intensity received before the decrease of intensity.

Thus, the control unit 115 may determine the absolute intensity received before the decrease of the light intensity from the lengths of the trails. In fact, the control unit 115 may determine the time constant τ for each imaging pixel 111 having generated one of the events of the time series of events, and the absolute intensity from the determined time constant τ.

Here, it should also be noted that the above effects will only arise for negative polarity events as will be described with respect to FIG. 4B. For an ideal OFF-ON pulse E_pix shown at the top of FIG. 4B the output voltage Vpr will start to decrease exponentially after the OFF transition as explained above. However, as the OFF-ON pulse has only a short OFF duration Vpr will decay only for a short time before it is quickly raised again. Thus, observed for a row of imaging pixels 111 movement of E_pix in the positive x-direction (representable by a black bar moving before a white background), will lead to voltage signals V_frame[t] and V_frame[t+Δt] that are nearly identical to E_pix. Therefore, also the difference signal Vcomp will be almost identical to the ideally expected signal Vcomp_ideal. Thus, in this situation there are no trails, but only an OFF-event followed by an ON-event.

In addition to the information on absolute intensities the control unit 115 may determine from the time series of events the speed with which the objects move. This can e.g. be done by observing the speed with which an ON-event front as the one shown in FIG. 3b) moves across the pixel array 110. Further, the control unit 115 may determine the relative amount of change of the received intensity for each of the events. A coarse measure of the relative change of intensity is given by the mere fact that an event was detected, since in this case the change must be larger than the respective threshold. Moreover, the change may be signaled from the pixel array 110 to the control unit 115 either as a number or by signaling one out of a plurality of ranges for the intensity change.

The control unit may reconstruct the time series of images based on the determined speed, the determined relative amount of change of the received intensity, and the deduced information on the absolute light intensity.

Alternatively or additionally the control unit may also determine from the time series of events that the solid state imaging device 100 is moving. If it is for example detected that several observed objects appear to be moving with the same speed in the same direction, this speed can be taken as the movement speed of the solid state imaging device 100. Events that were generated due to the movement of the solid state imaging device 100 can then be eliminated from the time series of events by the control unit 115 before deducing the information on the absolute light intensity. This ensures correct results that are not affected by egomotion of the solid state imaging device 100.

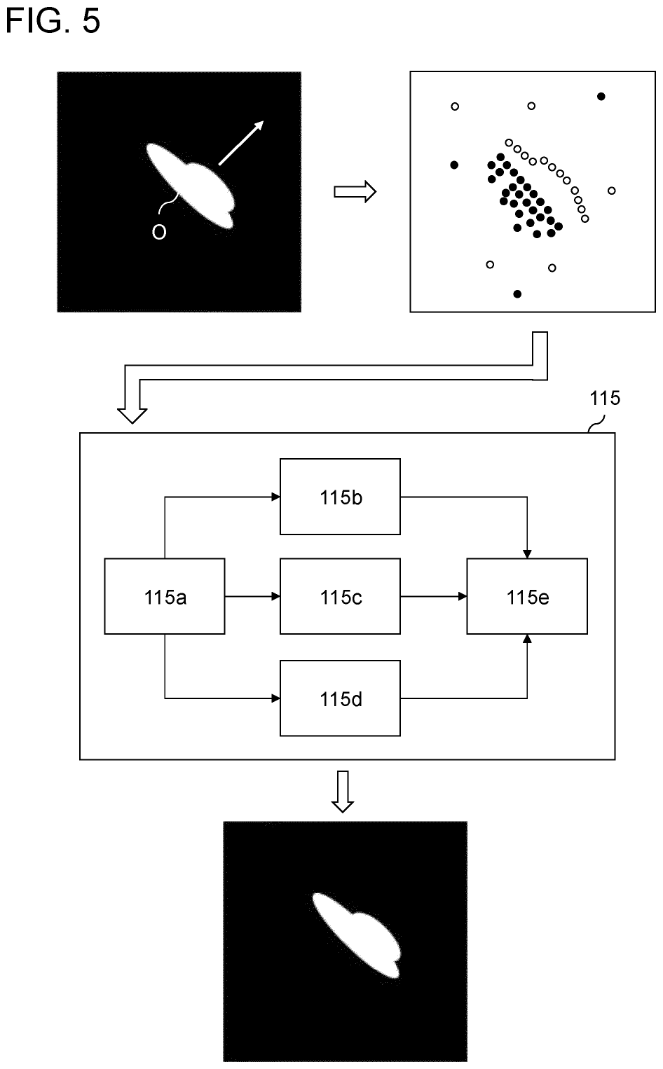

An overall process flow of the above is shown in FIG. 5. The process starts with observing a scene, e.g. the moving object O of FIG. 3a). From this scene a time series of event data is produced, showing positive and negative polarity events across the pixel array for each cycle of the time series. This time series of event data is then provided to the control unit 115.

The control unit 115 may preprocess the data in a preprocessing module 115a and remove e.g. events caused by noise or egomotion. In particular, noise can be distinguished from event trails, since events in the latter are highly correlated. The control unit 115 may determine the speed of various objects within the captured scene with speed determining module 115b as described above. The control unit 115 may also determine the relative brightness of events at edges of the moving objects by relative brightness module 115c as described above. Further, the control unit 115 determines the absolute brightness received from the moving objects as described above by absolute brightness module 115d. All the information obtained in this manner is fused in optimization module 115e in order to optimize an image reconstruction process carried out by the control unit 115. At the end of the process a time series of images of the captured scene is reconstructed that show the actually captured scene, although no full intensity information has been processed.

In this manner it is possible to capture moving images with the high time resolution and reduced computing requirements of EVS or DVS.

In this process the control unit 115 may deduce the information on the absolute light intensity based on a machine learning algorithm, e.g. in absolute brightness module 115d. For example, as loss function of a neural network to be minimized the time constant τ derived from the event trails may be used. Also, the control unit 115 may determine each of the speed with which the objects move and the relative amount of change of the received intensity based on a machine learning algorithm, e.g. in speed determining module 115b and relative brightness module 115c, respectively. Thus, these three kinds of information may be deduced each by a dedicated machine learning algorithm. The control unit 115 may reconstruct also the time series of images based on a dedicated machine learning algorithm, e.g. by optimization module 115e. Just the same, one machine learning algorithm may be used to directly produce the reconstructed image from the input event data.

Training data for the machine learning algorithms may be generated with an emulator that converts regular videos into event data, thereby reproducing the trail effect described above, while also being able to emulate different lighting conditions. The network can then be trained to minimize the difference between the input image series and the reconstructed image series. Just the same, emulator outputs may be generated that correspond to object movement speed, relative brightness and/or absolute brightness and allow to train machine learning algorithms directed to the deduction of these quantities.

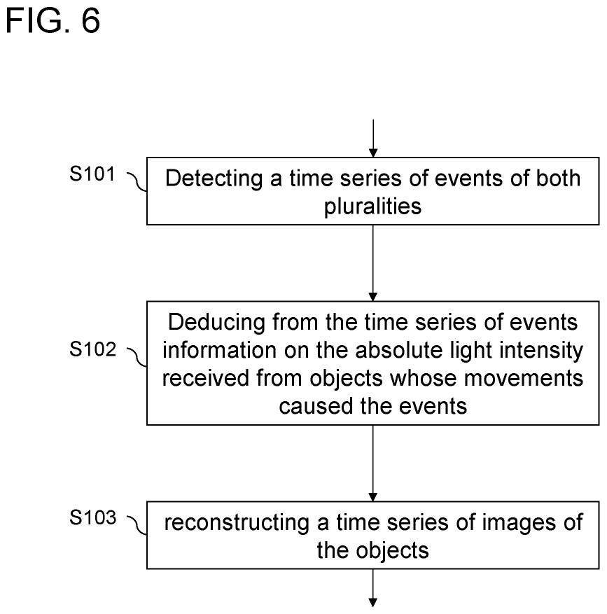

FIG. 6 shows a processing flow of a method for operating a solid state imaging device as described above. At S101 a time series of events of positive and negative polarities is detected as described above. At S102 from the time series of events information on the absolute light intensity received from objects whose movements caused the events are deduced. At S103 a time series of images of the objects is reconstructed.

In this manner accuracy and reliability of image reconstruction based on event data can be improved. Particular advantages can be achieved in the observation of very dark scenarios where noise and non-linear effects are important such as in applications of event vision sensors in the automotive field.

In the following further examples of the construction of the solid state imaging device described above and its applications will be given.

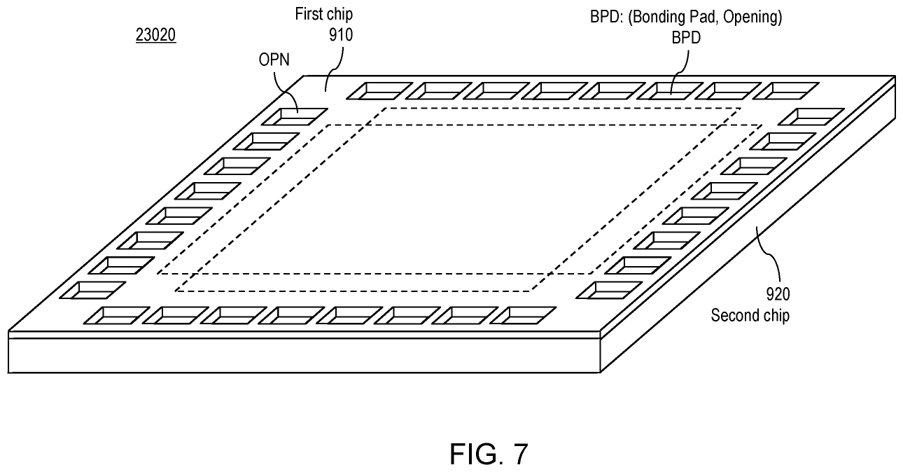

FIG. 7 is a perspective view showing an example of a laminated structure of a solid-state imaging device 23020 with a plurality of pixels arranged matrix-like in array form in which the functions described above may be implemented. Each pixel includes at least one photoelectric conversion element.

The solid-state imaging device 23020 has the laminated structure of a first chip (upper chip) 910 and a second chip (lower chip) 920.

The laminated first and second chips 910, 920 may be electrically connected to each other through TC(S)Vs (Through Contact (Silicon) Vias) formed in the first chip 910.

The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel, e.g., the photoelectric conversion elements arranged in array form. For example, the first chip 910 may include only the photoelectric conversion elements.

Alternatively, the first chip 910 may include further elements of each photoreceptor module. For example, the first chip 910 may include, in addition to the photoelectric conversion elements, at least some or all of the n-channel MOSFETs of the photoreceptor modules. Alternatively, the first chip 910 may include each element of the photoreceptor modules.

The first chip 910 may also include parts of the pixel back-ends 300. For example, the first chip 910 may include the memory capacitors, or, in addition to the memory capacitors sample/hold circuits and/or buffer circuits electrically connected between the memory capacitors and the event-detecting comparator circuits. Alternatively, the first chip 910 may include the complete pixel back-ends. With reference to FIG. 1A, the first chip 910 may also include at least portions of the readout circuit 140, the threshold generation circuit 130 and/or the controller 120 or the entire control unit.

The second chip 920 may be mainly a logic chip (digital chip) that includes the elements complementing the circuits on the first chip 910 to the solid-state imaging device 23020. The second chip 920 may also include analog circuits, for example circuits that quantize analog signals transferred from the first chip 910 through the TCVs.

The second chip 920 may have one or more bonding pads BPD and the first chip 910 may have openings OPN for use in wire-bonding to the second chip 920.

The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

Typically, the first chip 910 includes a p-type substrate and formation of p-channel MOSFETs typically implies the formation of n-doped wells separating the p-type source and drain regions of the p-channel MOSFETs from each other and from further p-type regions. Avoiding the formation of p-channel MOSFETs may therefore simplify the manufacturing process of the first chip 910.

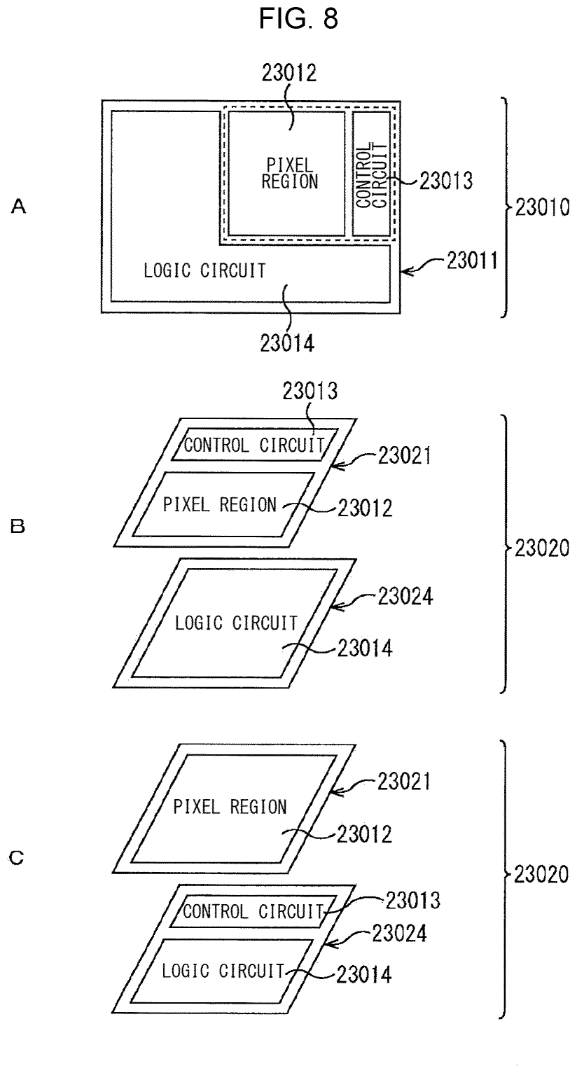

FIG. 8 illustrates schematic configuration examples of solid-state imaging devices 23010, 23020.

The single-layer solid-state imaging device 23010 illustrated in part A of FIG. 8 includes a single die (semiconductor substrate) 23011. Mounted and/or formed on the single die 23011 are a pixel region 23012 (photoelectric conversion elements), a control circuit 23013 (readout circuit, threshold generation circuit, controller, control unit), and a logic circuit 23014 (pixel back-end). In the pixel region 23012, pixels are disposed in an array form. The control circuit 23013 performs various kinds of control including control of driving the pixels. The logic circuit 23014 performs signal processing.

Parts B and C of FIG. 8 illustrate schematic configuration examples of multi-layer solid-state imaging devices 23020 with laminated structure. As illustrated in parts B and C of FIG. 8, two dies (chips), namely a sensor die 23021 (first chip) and a logic die 23024 (second chip), are stacked in a solid-state imaging device 23020. These dies are electrically connected to form a single semiconductor chip.

With reference to part B of FIG. 8, the pixel region 23012 and the control circuit 23013 are formed or mounted on the sensor die 23021, and the logic circuit 23014 is formed or mounted on the logic die 23024. The logic circuit 23014 may include at least parts of the pixel back-ends. The pixel region 23012 includes at least the photoelectric conversion elements.

With reference to part C of FIG. 8, the pixel region 23012 is formed or mounted on the sensor die 23021, whereas the control circuit 23013 and the logic circuit 23014 are formed or mounted on the logic die 23024.

According to another example (not illustrated), the pixel region 23012 and the logic circuit 23014, or the pixel region 23012 and parts of the logic circuit 23014 may be formed or mounted on the sensor die 23021, and the control circuit 23013 is formed or mounted on the logic die 23024.

Within a solid-state imaging device with a plurality of photoreceptor modules PR, all photoreceptor modules PR may operate in the same mode. Alternatively, a first subset of the photoreceptor modules PR may operate in a mode with low SNR and high temporal resolution and a second, complementary subset of the photoreceptor module may operate in a mode with high SNR and low temporal resolution. The control signal may also not be a function of illumination conditions but, e.g., of user settings.

### <Application Example to Mobile Body>

The technology according to the present disclosure may be realized, e.g., as a device mounted in a mobile body of any type such as automobile, electric vehicle, hybrid electric vehicle, motorcycle, bicycle, personal mobility, airplane, drone, ship, or robot.

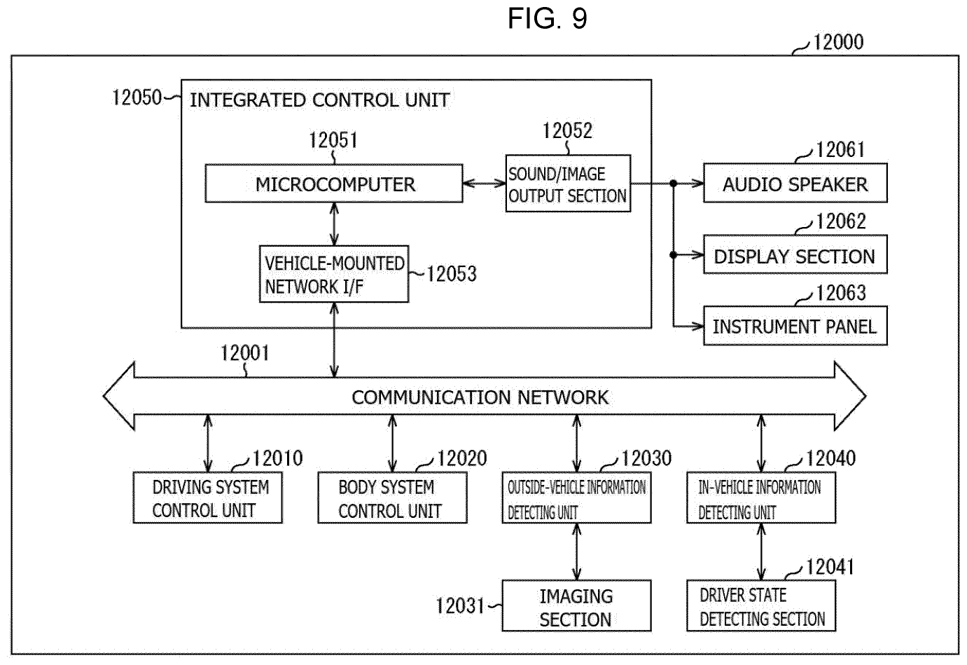

FIG. 9 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 9, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging sensor with event detection and photoreceptor modules according to the present disclosure. The imaging section 12031 may output the electric signal as position information identifying pixels having detected an event. The light received by the imaging section 12031 may be visible light, or may be invisible light such as infrared rays or the like.

The in-vehicle information detecting unit 12040 detects information about the inside of the vehicle and may be or may include a solid-state imaging sensor with event detection and photoreceptor modules according to the present disclosure. The in-vehicle information detecting unit 12040 is, for example, connected with a driver state detecting section 12041 that detects the state of a driver. The driver state detecting section 12041, for example, includes a camera focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 9, an audio speaker 12061, a display section 12062, and an instrument panel 12063 are illustrated as the output device. The display section 12062 may, for example, include at least one of an on-board display or a head-up display.

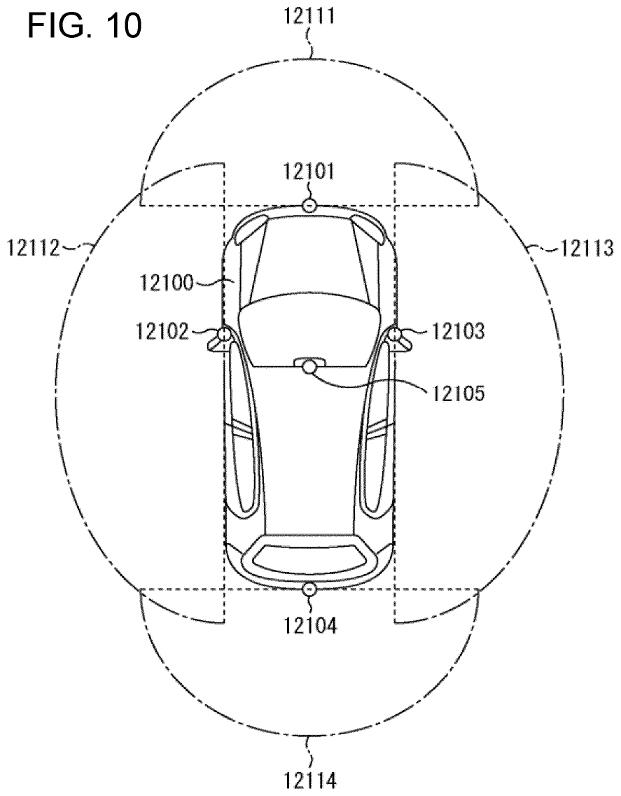

FIG. 10 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 10 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure is applicable has been described above. By applying the photoreceptor modules for obtaining event-triggered image information, the image data transmitted through the communication network may be reduced and it may be possible to reduce power consumption without adversely affecting driving support.

Additionally, embodiments of the present technology are not limited to the above-described embodiments, but various changes can be made within the scope of the present technology without departing from the gist of the present technology.

The solid-state imaging device according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

Note that the present technology can also be configured as described below:
(1) A solid state imaging device, comprising:
   a pixel array comprising a plurality of imaging pixels, each of which being capable to detect as a positive polarity event a rise of intensity of light falling on the imaging pixel which rise is larger than a respective first predetermined threshold or as a negative polarity event a fall of the intensity which fall is larger than a respective second predetermined threshold; and
   a control unit that is configured to receive a time series of the events of both polarities detected in the pixel array, to deduce from the time series of events information on the absolute light intensity received from objects whose movements caused the events, and to reconstruct a time series of images of the objects.
(2) The solid state imaging device according to (1), wherein
   the control unit is configured to detect trails of negative polarity events within the time series of events, which trails are generated by observing a movement of a bright object before a darker background, which trails consist at a given time each of a plurality of events, and the of movements of which trails follow the movement of the bright object; and
   the control unit is configured to determine the information on the absolute light intensity received from the bright object based on the detected trails that were generated by the bright object, in particular based on the lengths of the detected trails.
(3) The solid state imaging device according to (2), wherein
   an output voltage of the imaging pixels follows an exponential decay in time with time constant τ, after a decrease of the light intensity that is received by the imaging pixels;
   the time constant τ depends on the absolute intensity received before the decrease of the light intensity;
   the lengths of the trails depend on the time constant τ; and
   the control unit is configured to determine the absolute intensity received before the decrease of the light intensity from the lengths of the trails.
(4) The solid state imaging device according to (3), wherein
   the control unit is configured to determine the time constant τ for each imaging pixel having generated one of the events of the time series of events, and to determine the absolute intensity from the determined time constant τ.
(5) The solid state imaging device according to any one of (1) to (4), wherein
   the control unit is configured to determine from the time series of events the speed with which the objects move and the relative amount of change of the received intensity for each of the events; and
   the control unit is configured to reconstruct the time series of images based on the determined speed, the determined relative amount of change of the received intensity, and the deduced information on the absolute light intensity.
(6) The solid state imaging device according to any one of (1) to (5), wherein
   the control unit is configured to deduce the information on the absolute light intensity based on a machine learning algorithm.
(7) The solid state imaging device according to (5), wherein
   the control unit is configured to determine each of the speed with which the objects move and the relative amount of change of the received intensity based on a machine learning algorithm.
(8) The solid state imaging device according to any one of (1) to (7), wherein
   the control unit is configured to reconstruct the time series of images from the time series of event data based on a machine learning algorithm.
(9) The solid state imaging device according to any one of (1) to (8), wherein
   the control unit is configured to determine from the time series of events that the solid state imaging device is moving; and
   the control unit is configured to eliminate events that were generated due to the movement of the solid state imaging device before deducing the information on the absolute light intensity.
(10) A method for operating a solid state imaging device according to any one of (1) to (9), the method comprising
   detecting a time series of events of both pluralities;
   deducing from the time series of events information on the absolute light intensity received from objects whose movements caused the events; and
   reconstructing a time series of images of the objects.

1. A solid state imaging device, comprising:
a pixel array comprising a plurality of imaging pixels, each of which being capable to detect as a positive polarity event a rise of intensity of light falling on the imaging pixel which rise is larger than a respective first predetermined threshold or as a negative polarity event a fall of the intensity which fall is larger than a respective second predetermined threshold; and
a control unit that is configured to receive a time series of the events of both polarities detected in the pixel array, to deduce from the time series of events information on the absolute light intensity received from objects whose movements caused the events, and to reconstruct a time series of images of the objects.

2. The solid state imaging device according to claim 1, wherein
the control unit is configured to detect trails of negative polarity events within the time series of events, which trails are generated by observing a movement of a bright object before a darker background, which trails consist at a given time each of a plurality of events, and the of movements of which trails follow the movement of the bright object; and
the control unit is configured to determine the information on the absolute light intensity received from the bright object based on the detected trails that were generated by the bright object, in particular based on the lengths of the detected trails.

3. The solid state imaging device according to claim 2, wherein
an output voltage of the imaging pixels follows an exponential decay in time with time constant τ, after a decrease of the light intensity that is received by the imaging pixels;
the time constant τ depends on the absolute intensity received before the decrease of the light intensity;
the lengths of the trails depend on the time constant τ; and
the control unit is configured to determine the absolute intensity received before the decrease of the light intensity from the lengths of the trails.

4. The solid state imaging device according to claim 3, wherein
the control unit is configured to determine the time constant τ for each imaging pixel having generated one of the events of the time series of events, and to determine the absolute intensity from the determined time constant τ.

5. The solid state imaging device according to claim 1, wherein
the control unit is configured to determine from the time series of events the speed with which the objects move and the relative amount of change of the received intensity for each of the events; and
the control unit is configured to reconstruct the time series of images based on the determined speed, the determined relative amount of change of the received intensity, and the deduced information on the absolute light intensity.

6. The solid state imaging device according to claim 1, wherein
the control unit is configured to deduce the information on the absolute light intensity based on a machine learning algorithm.

7. The solid state imaging device according to claim 5, wherein
the control unit is configured to determine each of the speed with which the objects move and the relative amount of change of the received intensity based on a machine learning algorithm.

8. The solid state imaging device according to claim 1, wherein
the control unit is configured to reconstruct the time series of images based on a machine learning algorithm.

9. The solid state imaging device according to claim 1, wherein
the control unit is configured to determine from the time series of events that the solid state imaging device is moving; and
the control unit is configured to eliminate events that were generated due to the movement of the solid state imaging device before deducing the information on the absolute light intensity.

10. A method for operating a solid state imaging device that comprises a pixel array comprising a plurality of imaging pixels, each of which being capable to detect as a positive polarity event a rise of intensity of light falling on the imaging pixel which rise is larger than a respective first predetermined threshold or as a negative polarity event a fall of the intensity which fall is larger than a respective second predetermined threshold, the method comprising
detecting a time series of events of both pluralities;
deducing from the time series of events information on the absolute light intensity received from objects whose movements caused the events; and
reconstructing a time series of images of the objects.
